(19) United States
(12) Patent Application Publication
(10) Pub. No.: US 2009/0027327 A1
(43) Pub. Date: Jan. 29, 2009

(54) Liquid crystal display device and liquid crystal television

(75) Inventor: Takayoshi Urisu, Osaka (JP)

Correspondence Address: Yokoi & Co., U.S.A., Inc., 13700 Marina Pointe Drive #723, Marina Del Rey, CA, 90292, US

(73) Assignee: Funai Electric Co., Ltd., Osaka (JP)

(21) Appl. No.: 12/220,353

(22) Filed: Jul. 24, 2008

(30) Foreign Application Priority Data
Jul. 25, 2007 (JP) JP2007-193320

(51) Int. Cl. G09G 3/36

(52) U.S. Cl. 345/101

(57) ABSTRACT

A liquid crystal display device capable of correcting variation in luminance in a drive beginning period of the liquid crystal display device with a simple configuration by a microcomputer 15 referring to a luminance stabilization program and a look-up table recorded on a ROM 16 and executing contrast adjustment of the video signal by the video circuit 12 based on the look-up table, and a liquid crystal television using the liquid crystal display device are provided.

### CROSS-REFERENCES TO RELATED APPLICATIONS

The entire disclosure of Japanese Patent Application No. 2007-193320, filed Jul. 25, 2007, is expressly incorporated herein by reference.

### BACKGROUND OF THE INVENTION

1. Field of the Invention

The present invention relates to a liquid crystal display device correcting the luminance of the screen, and in particular to a liquid crystal display device and a liquid crystal television using a backlight and correcting the luminance varied owing to the panel characteristic.

2. Description of the Related Art

FIG. 2 is a diagram showing the luminance of the screen in a predetermined period after the power is switched ON. According to the drawing, the luminance of an image displayed on the screen increases in a predetermined period of time after the power is switched ON, namely in a drive beginning period, along a gentle curve, and then, decreases gradually to be saturated in a constant level. Therefore, the luminance on the screen decreases gradually to be darker, which causes the user as a viewing audience to feel uncomfortable. It is known that the variation in luminance caused when powering on as described above depends on the temperature characteristic of a cold cathode tube used as the backlight, and the temperature characteristic of sheets (in particular a lens sheet) of the optical system used inside the liquid crystal display device.

FIG. 9 is a perspective view showing the inside of the backlight in the related art. According to the drawing, the backlight 1 has a configuration including a cold cathode tube 2 for emitting light as a light source, a lamp reflector 3 for reflecting the light from the cold cathode tube 2 to orient the light in one direction, a light guide plate 4 for emitting the light from the cold cathode tube 2 to the front, namely on the liquid crystal display device side, a diffusing sheet 5 for diffusing the light from the light guide plate 4, and a lens sheet 6 for collecting the light diffused by the diffusing sheet 5 to the liquid crystal display device side. According to the configuration described above, the light emitted from the cold cathode tube 2 is reflected to the front face, the liquid crystal display device side, via the light guide plate 4 and emitted from the front face. On this occasion, the light from the light guide plate 4 is collected on the liquid crystal display device by the diffusing sheet 5 and the lens sheet 6, thus realizing homogeneous light emission.

On this occasion, the lens sheet 6 is made of acrylic resin, and the value of light collection varies with temperature. Therefore, the luminance value of the illumination provided to the liquid crystal display device varies until the temperature of the lens sheet 6 becomes constant. Further, in cooperation with the temperature characteristic of the luminance of the cold cathode tube 2, the luminance value of the light emitted from the backlight 1 varies, thus the variation in luminance in the drive beginning period as shown in FIG. 2 should be caused in the liquid crystal display device.

In order for eliminate the variation in luminance described above, the method as described below has been disclosed as a luminance correction method for a liquid crystal display device equipped with a backlight using a white LED. Specifically, timing correction unit for adjusting setting timing of a backlight luminance value is provided, and the timing correction unit makes the lighting of the backlight by an LED drive circuit follow the variation in the transmission of the liquid crystal display device, thereby correcting the luminance value (e.g., JP-A-2005-345552, hereinafter referred to as Patent Document 1).

Further, as a luminance correction method of a liquid display device using a luminance control device optical sensor having variations in error range between individual sensors, the following method has been disclosed. Specifically, a correspondence range table between the ambient luminance and the luminance of the liquid crystal display device is created, and the luminance of the LCD backlight is corrected using the correspondence range table (e.g., JP-A-2002-297103, hereinafter referred to as Patent Document 2). Further, in order for keeping constant luminance under various temperature conditions in a field sequential liquid crystal display device without a color filter, the following method has been disclosed. Specifically, by changing the time integral value of the light source luminance based on the temperature information or the maximum transmission information of the liquid crystal display element, a desired color representation is realized (e.g., JP-A-2001-272956, hereinafter referred to as Patent Document 3).

The invention disclosed in the Patent Document 1 described above has the following problem. That is, in the invention disclosed in the Patent Document 1, the white LED is used as the lamp for the backlight, and therefore, the invention is not applicable to the backlight using the cold cathode tube. Further, the object of the invention disclosed in the Patent Document 1 is adjustment of the luminance of the liquid crystal display in the ordinary use, and the invention is not for correcting the variation in luminance in the drive beginning period of the liquid crystal display device as is addressed by the present invention.

Further, the invention disclosed in the Patent Document 2 has the following problem. That is, the invention disclosed in the Patent Document 2 is for correcting the error range of the optical sensor, which corrects the luminance of the liquid crystal display, using the correspondence range table, but not for correcting the variation in luminance in the drive beginning period of the liquid crystal display device as is addressed by the present invention.

Further, the invention disclosed in the Patent Document 3 has the following problem. That is, the invention disclosed in the Patent Document 3 is for performing the correction for executing the desired color representation under various temperature conditions in the field sequential liquid crystal display device without a color filter, but not for correcting the variation in luminance in the drive beginning period of the liquid crystal display device as is addressed by the present invention.

### SUMMARY

The present invention has been made in view of the problem described above, and has an object of providing a liquid crystal display device capable of correcting the variation in luminance in the drive beginning period of the liquid crystal display device with a simple configuration, and a liquid crystal television using the liquid crystal display device.

In order for solving the problem described above, a liquid crystal display device according to the present invention includes a backlight using a cold cathode tube, a liquid crystal panel for varying transmission of source light from the backlight to display an image, video signal processing unit for executing image quality control of the image displayed on the liquid crystal panel section, temperature measurement unit for measuring temperature in the vicinity of a display surface of the liquid crystal display device, timing unit for measuring accumulated time from when the liquid crystal display device has been turned on, time-luminance correspondence recording unit having a value of luminance of the liquid crystal display device corresponding to the accumulated time from when power has been input to the liquid crystal display device with respect to a temperature in the vicinity of the display surface of the liquid crystal display device, and luminance correction unit for providing the video signal processing unit with an instruction of correcting the luminance of the liquid crystal display device referring in the time-luminance correspondence recording unit based on the measured temperature and the accumulated time.

In the invention having the configuration described above, the luminance correction unit refers to the time-luminance correspondence recording unit corresponding to the temperature measured by the temperature measurement unit, and provides the video signal processing unit with an instruction of executing the correction of the luminance. Thus, it becomes possible to correct the variation in luminance in the drive beginning period of the liquid crystal display device with a simple configuration using the time-luminance correspondence recording unit.

Further, according to the invention as an example of a specific configuration of correcting the luminance of the liquid crystal display device, in the configuration of the liquid crystal display device described above, the video signal processing unit has a configuration of controlling contrast of the image to be displayed on the liquid crystal display device, and the luminance correction unit provides the video signal processing unit with an instruction of control of contrast corresponding to the time based on the time-luminance correspondence recording unit.

According to the invention specifically configured as described above, the correction of the luminance of the liquid crystal display device in the drive beginning period is executed by the contrast control function provided to the video signal processing unit. The video signal processing unit has been implemented in the related art, and therefore, the correction method of the luminance can be realized with simple configuration without using an additional procedure.

The correction method of the luminance of the liquid crystal display device is not limited to the method of correcting the video signal input thereto. Therefore, according to the invention as an example of another specific configuration of correcting the luminance of the liquid crystal display device, the liquid crystal display device includes a backlight using a cold cathode tube, a liquid crystal panel section for varying transmission of source light from the backlight to display an image, backlight drive unit for generating a tube current for driving the backlight, temperature measurement unit for measuring temperature in the vicinity of a display surface of the liquid crystal display device, time-luminance correspondence recording unit having a value of luminance of the liquid crystal display device that corresponds to the accumulated time from when the liquid crystal display device has been turned on with respect to each of temperatures in the vicinity of the display surface of the liquid crystal display device, and tube current control unit for controlling a value of the tube current output by the backlight drive unit to the backlight, and luminance correction unit for outputting the value of the tube current, which corresponds to the time and output to the backlight, to the tube current control unit based on the value in the time-luminance correspondence recording unit.

According to the invention configured as described above, the luminance correction unit refers to the time-luminance correspondence recording unit according to the temperature measured by the temperature measurement unit, and provides the tube current control unit with an instruction of correcting the luminance. Thus, the tube current control unit executes the control of the tube current based on the instruction of the luminance correction unit to control the luminance of the backlight. According to such a correction method, since the correction of the luminance of the liquid crystal display device without executing the signal processing on the video signal, it becomes possible to prevent degradation of the video signal caused by the correction.

Further, according to the invention as an example of a specific configuration of the liquid crystal display device correction unit, in the configuration of the liquid crystal display device described above, the liquid crystal display device has a configuration of executing control with a microcomputer based on an instruction input, and the luminance correction unit has a configuration realized by the microcomputer.

According to the invention configured as described above, the liquid crystal display device correction unit can be realized by an existing microcomputer.

Further, according to the invention as an example of a specific configuration of the time-luminance correspondence recording unit, in the configuration of the liquid crystal display device described above, the time-luminance correspondence recording unit is realized by a look-up table the microcomputer refers to.

According to the invention configured as described above, the time-luminance correspondence recording unit is configured by the look-up table the microcomputer refers to. Therefore, the time-luminance correspondence recording unit can be recorded as data, thus the advantage of the present invention can be obtained with a simple configuration.

Further, according to another aspect of the invention, the time-luminance correspondence recording unit can be recorded as data, the advantage of the invention can be obtained with a simple configuration.

Further, according to the invention as a specific configuration for solving the problems described above, a liquid crystal television includes a liquid crystal display device having a backlight using a cold cathode tube, and a liquid crystal panel section for varying transmission of source light from the backlight to display an image, a video circuit for executing contrast control of a video signal input, a microcomputer for accepting a command from a remote controller and executing overall control, a ROM having a program for the microcomputer to start-up and a table, and a temperature sensor for measuring the temperature in the vicinity of a display surface of the liquid crystal display device, the microcomputer has a configuration for measuring accumulated time from when the liquid crystal display device has been turned on, and the ROM has a look-up table having a value of luminance of the liquid crystal display device corresponding to the accumulated time from when the liquid crystal display device has been turned on with respect to a temperature in the vicinity of the display surface of the liquid crystal display device, and a luminance correction program for the microcomputer to refer in the look-up table to the value of the luminance corresponding to the temperature of the liquid crystal display device measured by the temperature sensor, and provide the video circuit with an instruction of correcting contrast so as to correct the luminance of the image displayed on the liquid crystal display device during an initial period of the liquid crystal display device.

In the more specific configuration as described above, the same function and result as in the above aspects of the invention can obviously be obtained.

### BRIEF DESCRIPTION OF THE DRAWINGS

FIG. 1 is a block configuration diagram of a liquid crystal television.

FIG. 2 is a luminance-time characteristic diagram showing conditions of luminance variations at respective temperatures.

FIG. 3 is a time-luminance correlation diagram showing a luminance correction executed by a video circuit based on a look-up table.

FIG. 4 is a time-luminance correlation diagram showing the luminance after the correction has been executed.

FIG. 5 is a flowchart of a luminance stabilization program.

FIG. 6 is a block configuration diagram of a liquid crystal television 10 in a second embodiment of the invention.

FIG. 7 is a block diagram showing a configuration of a power supply circuit as an example.

FIG. 8 is a flowchart of a luminance stabilization program in the second embodiment of the invention.

FIG. 9 is a perspective view showing the inside of the backlight in the related art.

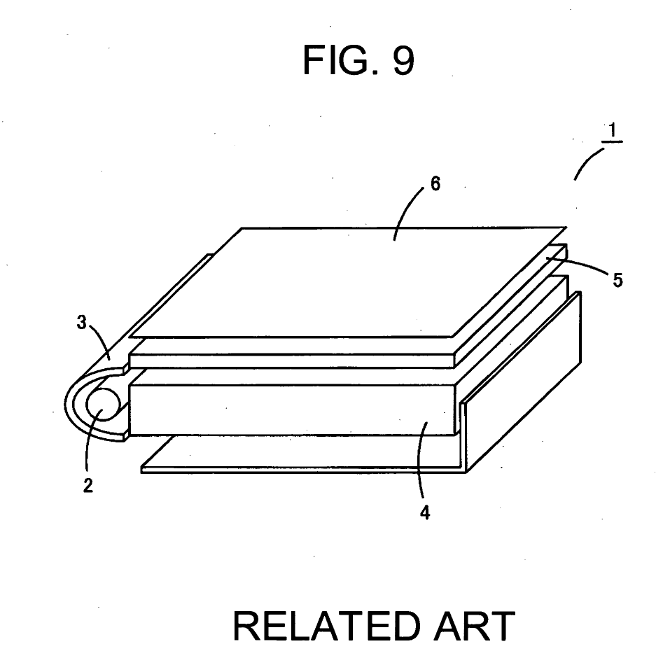

### DETAILED DESCRIPTION OF THE PREFERRED EMBODIMENT

As a specific explanation of the liquid crystal display device according to the present invention, a liquid crystal television using the liquid crystal display device will mainly be explained. However, the present invention is not limited to the liquid crystal television. Hereinafter, some embodiments of the present invention will be explained along the following order.

1. First Embodiment
1-1. Configuration of Liquid Crystal Television
1-2. Luminance Correction Method in Drive Beginning Period

2. Summary of First Embodiment

3. Second Embodiment

4. Summary of Second Embodiment

1. First Embodiment

1-1. Configuration of Liquid Crystal Television

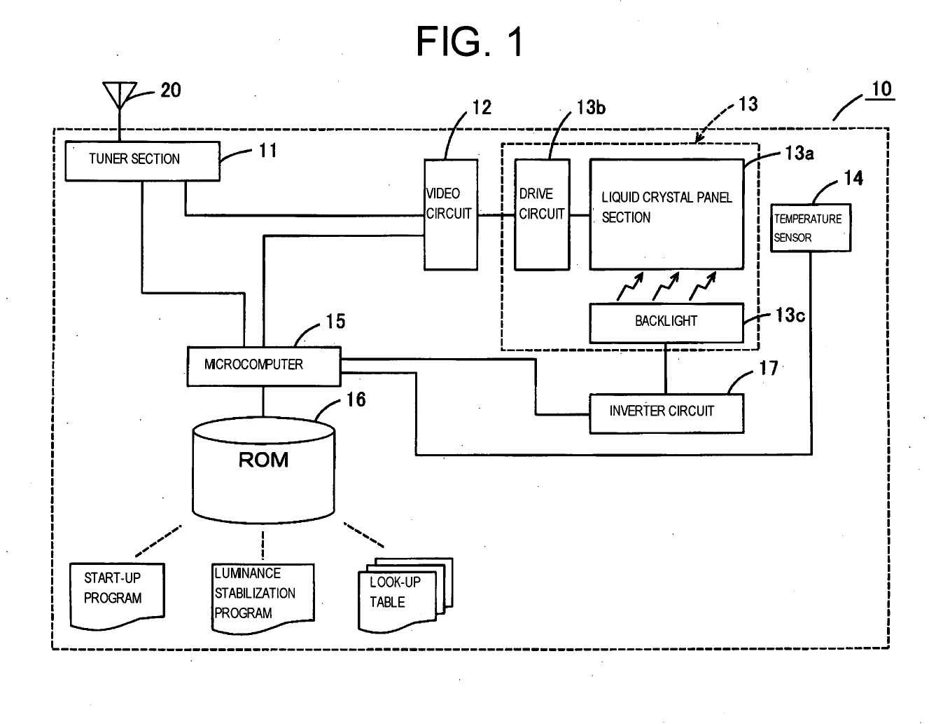

Hereinafter, a liquid crystal television as a first embodiment of the present invention will be explained with reference to FIGS. 1 through 5. FIG. 1 is a block configuration diagram of the liquid crystal television. The liquid crystal television 10 is for displaying pictures based on a video signal such as a television signal input therein. Therefore, the liquid crystal television 10 has a configuration including a tuner section 11 for extracting predetermined video signal and audio signal from the television broadcasting received by an antenna 20, a video circuit 12 (video signal processing unit) for executing a predetermined signal processing on the video signal received by the tuner 11, a liquid crystal display device 13 for displaying pictures based on the video signal from the video circuit 12, a microcomputer 15 for controlling the entire liquid crystal television 10, a ROM 16 for recording a program for starting-up the microcomputer 15 and a table (time-luminance correspondence recording unit), a temperature sensor 14 (temperature measurement unit) for measuring the temperature of the liquid crystal display device 13, and an inverter circuit 17 for supplying the backlight of the liquid crystal display device 13 with power.

The function of the liquid crystal television 10 having the configuration described above will hereinafter be explained. The tuner section 11 extracts the video signal and the audio signal corresponding to predetermined broadcasting from the television broadcasting received by the antenna 20. The video circuit 12 forms image data for forming one frame based on the video signal extracted by the tuner 11. The image data generated on this occasion is composed of the luminance/color-difference signals (R-Y, B-Y), which are difference components between the R, G signals out of the color signals R, G, B for forming a picture, and the Y signal representing the luminance. The video circuit 12 generates the color signals R, Q,B from the luminance/color-difference signals input therein, and divides the image data thus generated in accordance with the pixels of the liquid crystal display device 13 arranged in a matrix. Specifically, in the case in which the aspect ratio of the liquid crystal display device 13 is the VGA of 640×480, the image data forming one frame is divided equally into 640×480, or in the case in which the aspect ratio is the XGA of 1024×768, the image data is divided equally into 1024×768.

Further, the video circuit 12 executes the predetermined signal processing on the image data obtained by the dividing operation, and outputs the result to the liquid crystal display device 13. As examples of the signal processing executed by the video circuit 12 on this occasion, a contrast control for adjusting the white level and the black level of the video signal, a gamma correction corresponding to the display characteristic of the liquid crystal display device 13, and so on can be cited. Since the contrast control and the gamma correction are well-known technologies, the explanations therefor will be omitted here. The signal processing described above is automatically executed based on the color signals of the differential signals (R-Y, B-Y) and the luminance signal Y, or alternatively, executed in response to the microcomputer 15 accepting the operation by the user from a remote controller.

The image data on which the signal processing is executed by the video circuit 12 is output to the liquid crystal display device 13. The liquid crystal display device 13 has a configuration including a liquid crystal panel section 13a composed of pixels arranged in a matrix and having respective color filters of R, G, B, a drive circuit 13b for converting the image data input from the video circuit 12 into an analog signal and applying the analog signal to each of the pixels of the liquid crystal panel section 13a, and a backlight 13c located on the back face of the liquid crystal panel section 13a and emitting the source light. According to the configuration described above, the image data output from the video circuit 12 is converted by the drive circuit 13b into the analog signal with a predetermined voltage value, and then applied to each of the pixels of the liquid crystal panel section 13a arranged in a matrix, thus changing the molecular arrangement of the liquid crystal material encapsulated in the pixels to display the image.

Further, on the back face of display surface of the liquid crystal display device 13, there is disposed the backlight 13c, thus the source light from the backlight 13c is provided to the liquid crystal panel section 13a. On this occasion, in the pixels of the liquid crystal panel 13a accepting the light from the backlight 13c, the transmission of light is varied between the pixels in accordance with the voltages applied by the drive circuit 13b. Thus, the grayscale is varied between the pixels, thereby displaying the image in one frame of the liquid crystal display device 13. In the backlight 13c of the present embodiment of the invention, the cold cathode tube is used as the lamp. As a shape of the cold cathode tube, a U-tube and a pseudo-U-tube can be cited. The shape of the cold cathode tube can appropriately be selected or designed in accordance with the specification of the liquid crystal display device 13.

Although the liquid crystal television 10 displays images on the liquid crystal display device 13 using the configuration described above, a variation in luminance occurs in the drive beginning period of the liquid crystal display device 13. The variation in luminance described above sometimes makes the viewing audience misunderstand that a failure has occurred in the liquid crystal television 10 itself, thus bringing discomfort to the viewing audience. Therefore, the liquid crystal television 10 according to the present invention is arranged to have a configuration for automatically correcting the variation in luminance in the drive beginning period described above, thereby reducing the uncomfortable feeling of the viewing audience. In order for achieving the configuration described above, the liquid crystal television 10 according to the present invention is provided with the temperature sensor 14 for measuring the temperature of the liquid crystal display device 13 and a look-up table for allowing the microcomputer 15 to issue instructions for correcting the luminance based on the temperature measured by the temperature sensor 14 recorded on the ROM 16. Further, the microcomputer 15 is capable of measuring time as an essential function, and measures the accumulated time from when the power has been switched ON. In this respect, the microcomputer 15 forms timing unit. Further, the microcomputer 15 and the ROM 16 realize luminance correction unit in cooperation with each other. A specific configuration thereof will hereinafter be explained.

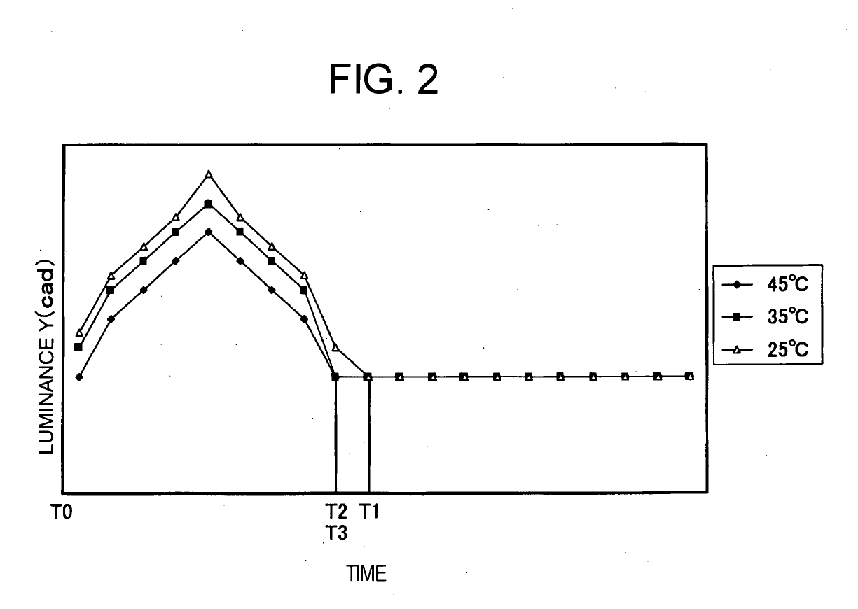

1-2. Luminance Correction Method in Drive Beginning Period The variation in the luminance of the liquid crystal display device 13 in the drive beginning period is caused by the temperature characteristic of the cold cathode tube forming the backlight 13c and the temperature characteristic of the lens sheet and so on. Therefore, the liquid crystal television 10 according to the present invention measures the temperature in the vicinity of the liquid crystal display device 13 using the temperature sensor 14 to correct the luminance of the liquid crystal display device based on the temperature thus measured. FIG. 2 is a luminance-time characteristic diagram showing conditions of luminance variations at respective temperatures. FIG. 2 shows the three conditions in which the liquid crystal display device 13 is at temperature of 25° C., 35° C., and 45° C., respectively, as an example. According to FIG. 2, in either case with the temperature of 25° C., 35° C., or 45° C., the luminance Y varies along a gentle curve gradually increasing and then decreasing in the period from when the power has been switched ON to the time point T1 (25° C.), T2 (35° C.), or T3 (45° C.), and is thereafter saturated in a constant level of Ym. Therefore, in order for reducing the variation in luminance before the time points T1, T2, and T3 shown in FIG. 2, the luminance Y is converted into the saturated luminance Ym by an inverse correction.

Accordingly, in the first embodiment of the present invention, the variation in luminance in the drive beginning period is corrected using the contrast control of the video circuit 12. Specifically, the luminance value in the image data is varied using the contrast control function so that the variation in luminance in the period between T0 and T1, T2, or T3 shown in FIG. 2 is inverse-corrected to make the luminance value substantially the same as the saturated value Ym. Therefore, in order for eliminating the variation in luminance in the drive beginning period using the contrast control of the video circuit 12 described above, the ROM 16 has a configuration of recording the look-up table and the luminance correction program for allowing the microcomputer 15 to execute the contrast control corresponding to the temperature measured by the temperature sensor 14.

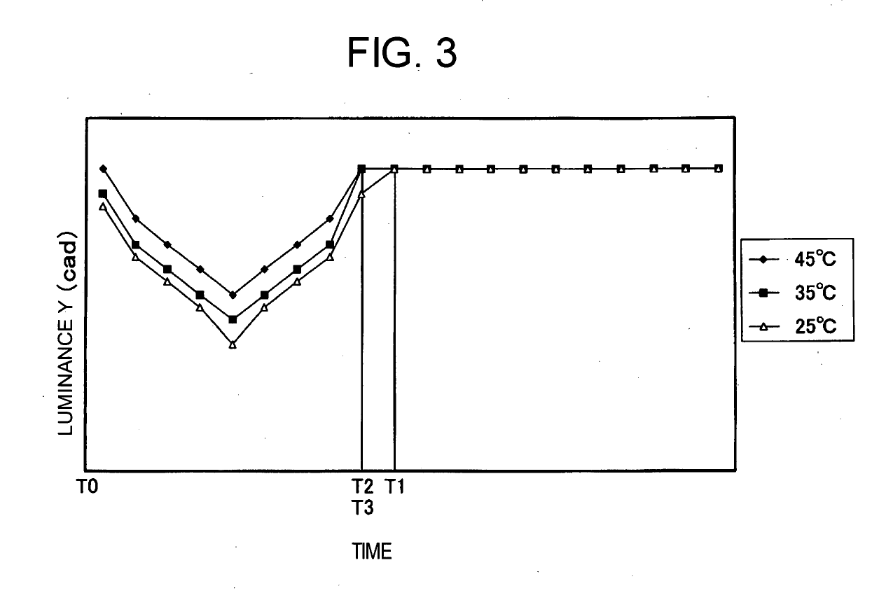

FIG. 3 is a time-luminance correlation diagram showing the luminance correction executed by the video circuit 12 based on the look-up table, and shows target luminance Y determined by the video circuit 12 without considering the influence of the temperature.

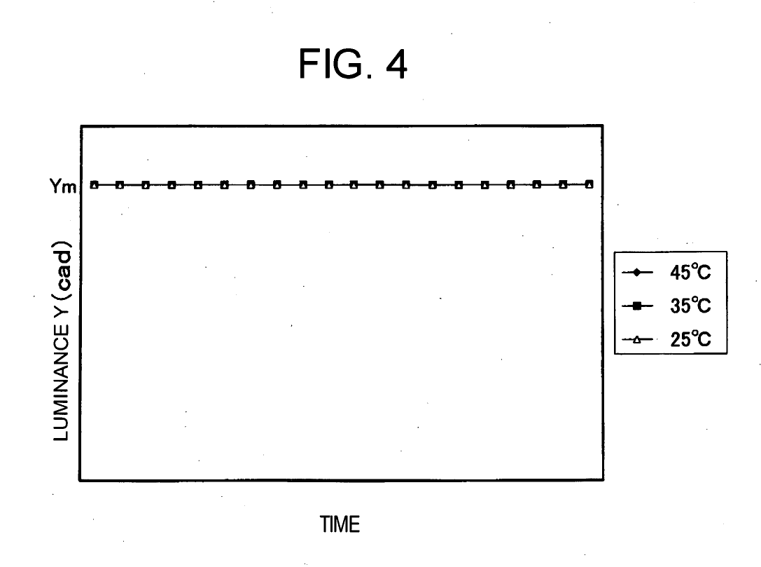

FIG. 4 is a time-luminance correlation diagram showing the actual luminance after the correction has been executed thereon, and shows that the luminance is kept at the constant saturated luminance Ym irrespective of the accumulated time in all of the cases with respective temperatures (25° C., 35° C., and 45° C.).

By the video circuit 12 executing the contrast control in the period between the time periods T0 and T1, T2, or T3 at the corresponding temperature (25° C., 35° C., or 45° C.) as shown in FIG. 3, the liquid crystal display device 13 performs display with the saturated luminance Ym shown in FIG. 4 at the corresponding temperature. Specifically, the contrast control of previously subtracting the variation in luminance in the temperature characteristic of the liquid crystal display device 13 from the luminance value of the image data is executed. Thus, the luminance of the display on the liquid crystal display device 13 corresponding to the image data becomes the saturated luminance Ym irrespective of the temperature. It should be noted that the contrast control is executed by modifying the white level or the black level of the video signal when executing the signal processing on the color signals R, G, B. Therefore, the luminance is not corrected directly. However, according to the relationship between the luminance and the color signals, the luminance Y can be calculated from the color signals R, G, B along the following formula.

Y=0.30R+0.59G+0.11B (1)

Therefore, the correction value of the luminance shown in FIG. 3 can be generated using the color signals R, G, B.

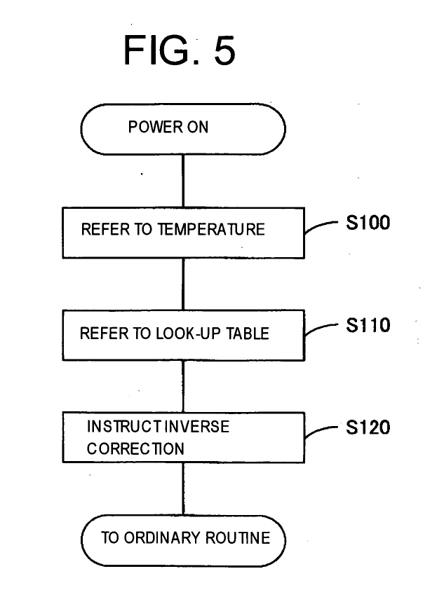

The luminance of the image data on which the contrast control described above has been executed becomes to have the value approximate to the saturated luminance Ym as shown in FIG. 4. The microcomputer 15 provides the video circuit 12 with an instruction of executing the contrast control corresponding to the look-up table described above on the image data, thereby correcting the variation in the luminance of the image displayed on the liquid crystal display device 13. The correction on the luminance by the microcomputer 15 described above is executed based on the luminance stabilization program recorded on the ROM 16. Hereinafter, the luminance stabilization program executed by the microcomputer 15 will be explained with reference to the flowchart. FIG. 5 is the flowchart of the luminance stabilization program. When the power is switched ON by the remote controller or the like, and the power is supplied to the liquid crystal display device 13, the microcomputer 15 refers to the luminance stabilization program on the ROM 16 and moves to the program from the ordinary routine. Subsequently, the microcomputer 15 accepts the data of the temperature in the vicinity of the liquid crystal display device 13 output from the temperature sensor 14 (step S100). The temperature value detected by the temperature sensor 14 can appropriately be changed in accordance with the luminance characteristic of the liquid crystal display-device.

Subsequently, the microcomputer 15 refers to the look-up table recorded on the ROM 16 (step S110). On this occasion, the microcomputer 15 refers to the values for the contrast processing corresponding to the temperature input from the temperature sensor 14 in the look-up table. On this occasion, by recording a table for providing correspondence between the signal input from the temperature sensor 14 and the address, on which the correction value of the luminance in the corresponding temperature is recorded, on the ROM 16, it becomes easy for the microcomputer 15 to refer to the look-up table. Based on the value of the contrast processing thus obtained, the microcomputer 15 provides the video circuit 12 with the instruction of executing the contrast processing on the image data thus input (step S120). Thus, in response to the instruction from the microcomputer 15, the video circuit 12 executes the contrast processing on the image data thus input for a predetermined period of time.

2. Summary of First Embodiment

As described above, the liquid crystal television 10 corrects the variation in luminance in the drive beginning period of the liquid crystal display device 13 using the contrast processing executed by the video circuit in response to the instruction of the microcomputer 15. Thus, it becomes possible to reduce the uncomfortable feeling of the viewing audience by correcting the variation in luminance in the drive beginning period of the liquid crystal display device 13 using the contrast processing by the video circuit 12. Further, since there is no need for implementing additional circuit for executing the correction of the luminance, it becomes possible to execute the correction of the luminance with a simple configuration.

3. Second Embodiment

In the first embodiment of the invention described above, the variation in luminance in the drive beginning period is corrected using the contrast processing executed by the video circuit 12. However, the method of correcting the luminance is not limited to the correction of the image date by the video circuit 12 as described above, but can be a method of correcting the luminance of the source light emitted from the backlight 13c. Therefore, in the second embodiment according to the present invention, there is adopted a configuration of executing the inverse correction of the luminance of the liquid crystal display device 13 by controlling the value of the tube current flowing through the backlight 13c.

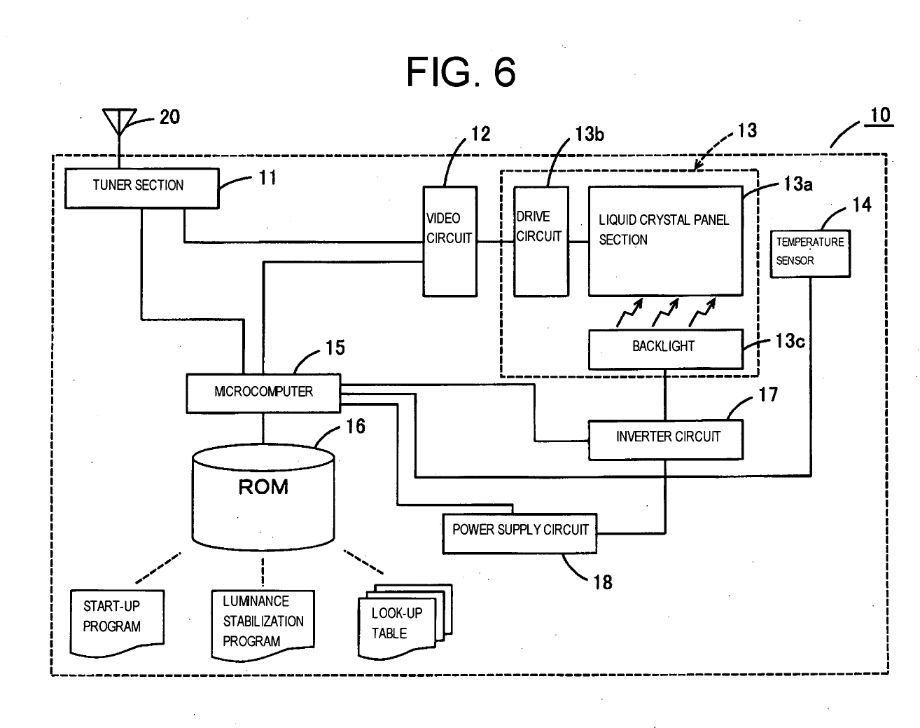

FIG. 6 is a block configuration diagram of the liquid crystal television 10 in the second embodiment of the invention. In the drawing, the blocks denoted with the same reference numerals as the blocks shown in FIG. 1 have the same configurations as those of the blocks denoted with the same reference numerals shown in FIG. 1. The liquid crystal television 10 has the configuration for driving the backlight 13c, including a power supply circuit 18 for generating a stabilized power from the commercial power, and an inverter circuit 17 for driving a plurality of cold cathode tubes 13c1 based on the power from the power supply circuit 18. Further, the power supply circuit 18 described above is connected to the microcomputer 15, and controls the backlight 13c along the command of the microcomputer 15. According to the configuration described above, in the normal operations, the power supply circuit 18 generates the stabilized power based on the power supplied from the commercial power supply to drive the inverter circuit 17. The tube current flows through the cold cathode tubes in response to the drive of the inverter circuit 17, and light is emitted from the backlight 13c in response to lighting of the cold cathode tubes.

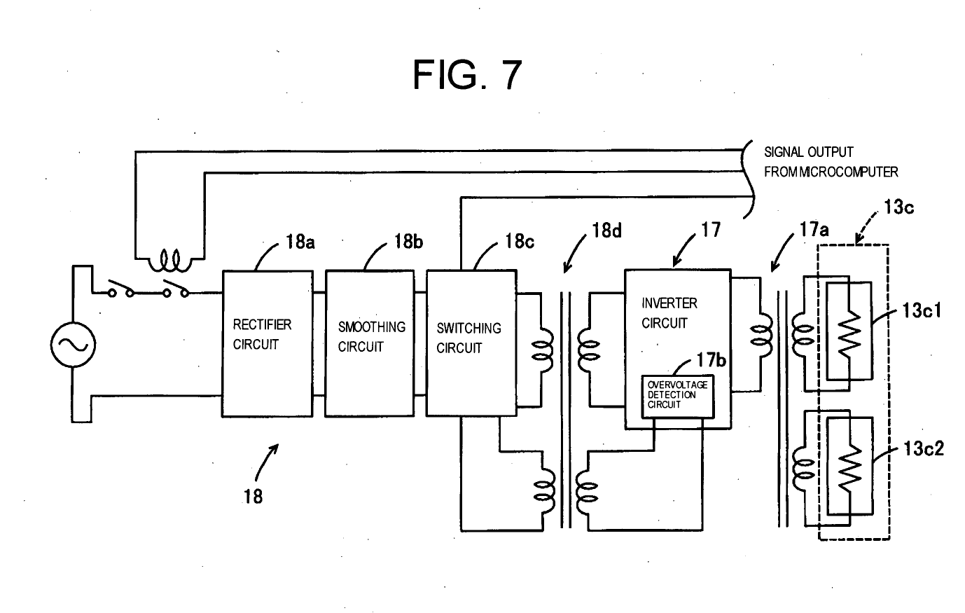

Then, the luminance correction method in the second embodiment of the present invention will be explained with reference to FIG. 7. FIG. 7 is a block diagram showing a configuration of the power supply circuit as an example. According to the drawing, the power supply circuit 18 has the configuration including a rectifier circuit 18a for rectifying the commercial power, a smoothing circuit 18b for smoothing the power thus rectified, and a switching circuit 18c for generating an alternating-current power with predetermined voltages based on the power thus smoothed. According to the configuration described above, the commercial power supplied from the commercial power supply is converted into the direct-current power by the rectifier circuit 18a and the smoothing circuit 18b, further converted into the alternating-current power by the switching circuit 18c, and then supplied to the inverter circuit 17 via a transformer 18d. On this occasion, the switching circuit 18c generates the supply voltage to be supplied to the inverter circuit 17 by driving a transistor implemented therein at a predetermined duty ratio. The switching operation of the switching circuit 18c described above is controlled by the microcomputer 15, by modifying the duty ratio in the transistor based on the control signal from the microcomputer 15, thereby generating a desired voltage.

The inverter 17 amplifies the power with a predetermined frequency by resonance based on the power supply voltage supplied from the power supply circuit 18, and supplies the cold cathode tubes 13c1 with the power via the transformer 17a. Further, the inverter circuit 17 has an overvoltage detection circuit 17b inside thereof, and controls driving of the switching circuit 18c on the power supply circuit 18 side by feedback when an abnormal voltage is detected in the output voltage to the inverter circuit 17.

In the configuration of the second embodiment of the invention described above, the microcomputer 15 controls the switching operation of the switching circuit 18c based on the look-up table, and thus adjusting the voltage output to the inverter circuit 17. Thus, the voltage supplied from the inverter circuit 17 to the cold cathode tubes 13c1 is varied, and as a result, the tube current flowing through the cold cathode tubes 13c1 is varied. Thus, the luminance with which the backlight 13c illuminates the liquid crystal display device 13 is varied, and the luminance of the liquid crystal display device can be controlled. Further, as the look-up table the microcomputer 15 refers to on this occasion, any tables having the duty ratio for generating the voltage to be supplied to the inverter circuit 17 recorded thereon so that a predetermined tube current flows through the cold cathode tubes can be used. A flow of the process to be executed by the microcomputer 15 using the look-up table will hereinafter be explained.

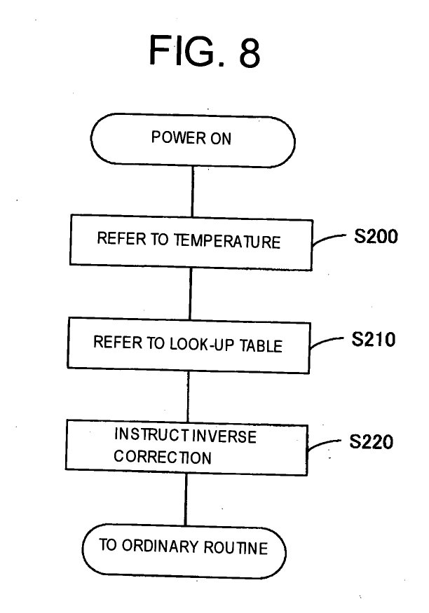

FIG. 8 is a flowchart of a luminance stabilization program in the second embodiment of the invention. When the power is switched ON by the remote controller or the like, and the power is supplied to the liquid crystal display device 13, the microcomputer 15 refers to the luminance stabilization program on the ROM 16 and moves to the program from the ordinary routine. Subsequently, the microcomputer 15 accepts the data of the temperature in the vicinity of the liquid crystal display device 13 output from the temperature sensor 14 (step S200). Further, the microcomputer 15 refers to the look-up table recorded on the ROM 16 (step S210). Further, on this occasion, the microcomputer 15 retrieves the voltage value, which should be generated by the switching circuit 18c and corresponds to the temperature input from the temperature sensor 14, from the look-up table.

The microcomputer 15 then changes the duty ratio of the transistor of the switching circuit 18c based on the voltage value thus retrieved (step S220). Thus, the switching circuit 18c generates the voltage by the switching operation with a predetermined duty ratio in response to the instruction from the microcomputer 15, and outputs the voltage to the inverter circuit 17. The inverter circuit 17 amplifies the voltage by resonance, and then applies the voltage to the cold cathode tubes 13c1. Thus, the predetermined tube current flows through the cold cathode tubes 13c1, and the cold cathode tubes 13c1 illuminate the liquid crystal display device 13. Therefore, the backlight 13c emits the source light with the corrected luminance to the liquid crystal display device 13 under the control of the microcomputer 15.

4. Summary of Second Embodiment

According to the second embodiment of the present invention described above, the liquid crystal television 10 corrects the variation in luminance in the drive beginning period of the liquid crystal display device 13 by controlling the tube current flowing through the cold cathode tubes of the backlight 13c along the control by the microcomputer 15. Thus, the uncomfortable feeling of the viewing audience caused by the variation in luminance in the drive beginning period is prevented. Further, in the second embodiment, since no corrections related to the correction of the luminance are executed on the image data input, there can be obtained an advantage that the variation in luminance in the drive beginning period of the liquid crystal display device 13 can be corrected while preventing the degradation of the image displayed on the liquid crystal display device 13 caused by the correction, in addition to the advantage described above.

It should be noted that it is obvious that the present invention is not limited to the embodiments described above. It is obvious to those skilled in the art that the following matters are disclosed as embodiments of the present invention.
To apply the members replaceable with each other or configurations and so on replaceable with each other disclosed in the embodiments described above with the combination thereof appropriately modified.
To appropriately replace the member, configuration, and so on not disclosed in the embodiments described above and included in the known technology and replaceable with the member, configuration, and so on disclosed in the embodiments described above, or to apply the member, configuration, and so on not disclosed in the embodiments described above and included in the known technology and replaceable with the member, configuration, and so on disclosed in the embodiments described above with the combination thereof modified.
To appropriately replace the member, configuration, and so on disclosed in the embodiments described above with the member, configuration, and so on not disclosed in the embodiments described above and assumed by those skilled in the art to be the replacements of the member, configuration, and so on disclosed in the embodiments described above, or to apply the member, configuration, and so on not disclosed in the embodiments described above and assumed by those skilled in the art to be the replacements of the member, configuration, and so on disclosed in the embodiments described above with the combination thereof modified.

While the invention has been particularly shown and described with respect to preferred embodiments thereof, it should be understood by those skilled in the art that the foregoing and other changes in form and detail may be made therein without departing from the spirit and scope of the invention as defined in the appended claims.

What is claimed is:

1. A liquid crystal television comprising:
a backlight using a cold cathode tube;
a liquid crystal display device for varying transmission of a source light from the backlight to display an image;
a video circuit for executing contrast control of a video signal input;
a microcomputer for accepting a command from a remote controller and executing overall control;
a ROM having a program for the microcomputer to start-up and a table; and
a temperature sensor for measuring a temperature in a vicinity of a display surface of the liquid crystal display device,
the microcomputer has a configuration for measuring accumulated time from when the liquid crystal display device has been turned on, and
the ROM has
a look-up table having a value of luminance of the liquid crystal display device corresponding to the accumulated time from when the liquid crystal display device has been turned on with respect to a predetermined temperature in the vicinity of the display surface of the liquid crystal display device, and
a luminance correction program for the microcomputer to refer in the look-up table to the value of the luminance corresponding to the temperature of the liquid crystal display device measured by the temperature sensor, and provide the video circuit with an instruction of correcting contrast to correct the luminance of the image displayed on the liquid crystal display device during an initial period of the liquid crystal display device.

2. A liquid crystal display device comprising:
a backlight using a cold cathode tube;
a liquid crystal panel for varying transmission of a source light from the backlight to display an image;
video signal processing unit for executing image quality control of the image displayed on the liquid crystal panel section;
temperature measurement unit for measuring temperature in a vicinity of a display surface of the liquid crystal display device;
timing unit for measuring accumulated time from when the liquid crystal display device has been turned on;
time-luminance correspondence recording unit having a value of luminance of the liquid crystal display device corresponding to the accumulated time from when power has been input to the liquid crystal display device with respect to a temperature in the vicinity of the display surface of the liquid crystal display device; and
luminance correction unit for providing the video signal processing unit with an instruction of correcting the luminance of the liquid crystal display device referring in the time-luminance correspondence recording unit based on the measured temperature and the accumulated time.

3. The liquid crystal display device according to claim 2,
wherein the video signal processing unit has a configuration of controlling contrast of the image to be displayed on the liquid crystal display device, and
the luminance correction unit provides the video signal processing unit with an instruction of control of contrast corresponding to the time based on the time-luminance correspondence recording unit.

4. A liquid crystal display device comprising:
a backlight using a cold cathode tube;
a liquid crystal panel section for varying transmission of a source light from the backlight to display an image;
backlight drive unit for generating a tube current for driving the backlight;
temperature measurement unit for measuring temperature in the vicinity of a display surface of the liquid crystal display device;
time-luminance correspondence recording unit having a value of luminance of the liquid crystal display device that corresponds to the accumulated time from when the liquid crystal display device has been turned on with respect to each of temperatures in the vicinity of the display surface of the liquid crystal display device;
tube current control unit for controlling a value of the tube current output by the backlight drive unit to the backlight; and
luminance correction unit for outputting the value of the tube current, which corresponds to the time and output to the backlight, to the tube current control unit based on the value in the time-luminance correspondence recording unit.

5. The liquid crystal display device according to claim 2,
wherein the liquid crystal display device has a configuration of executing control with a microcomputer based on an instruction input, and
the luminance correction unit is realized by the microcomputer.

6. The liquid crystal display device according to claim 5,
wherein the time-luminance correspondence recording unit is realized by a look-up table the microcomputer refers to.

7. The liquid crystal display device according to claim 5, further comprising:
a power supply circuit having
a rectifier circuit for rectifying commercial power,
a smoothing circuit for smoothing the power rectified,
a switching circuit for generating alternating-current power having a predetermined voltage based on the power smoothed, and
a transformer to which the alternating-current power is input; and
an inverter circuit connected to the power supply circuit via the transformer, and for generating alternating-current power for lighting a cold cathode tube,
wherein the microcomputer controls a duty ratio in the switching circuit referring to the look-up table to adjust the voltage output to the inverter circuit, thereby controlling the voltage supplied to the cold cathode tube.

8. The liquid crystal display device according to claim 7,
wherein the inverter circuit has an overvoltage detection circuit inside, and controls drive of the switching circuit on the power supply circuit side by feedback in response to the overvoltage detection circuit detecting an abnormal voltage in the voltage output to the inverter circuit.

9. The liquid crystal display device according to claim 8,
wherein the look-up table has duty ratio for generating a voltage supplied to the inverter circuit so that a predetermined tube current flows through the cold cathode tube.

10. The liquid crystal display device according to claim 9,
wherein the microcomputer refers to a luminance stabilization program recorded on a predetermined ROM to execute the luminance stabilization program, and in response to acceptance of data of temperature in the vicinity of the liquid crystal display device output from the temperature sensor, refers to the look-up table recorded on the ROM to retrieve a voltage value corresponding to the temperature, varies the duty ratio of the switching circuit based on the voltage value,
the switching circuit generates a voltage by a switching operation with the duty ratio varied by the microcomputer to output the voltage to the inverter circuit in response to an instruction from the microcomputer, and
the inverter circuit applies the predetermined voltage to the cold cathode tube.
